(19) United States
(12) Patent Application Publication
(10) Pub. No.: US 2024/0053757 A1
(43) Pub. Date: Feb. 15, 2024

(54) FACILITATING INDOOR VEHICLE NAVIGATION FOR OBJECT COLLECTION

(71) Applicant: Capital One Services, LLC, McLean, VA (US)

(72) Inventors: Mohamed SECK, Aubrey, TX (US); Eric SCHULTZ, Trappe, PA (US); Ebrima N. CEESAY, Vienna, VA (US)

(73) Assignee: Capital One Services, LLC, McLean, VA (US)

(21) Appl. No.: 17/818,677

(22) Filed: Aug. 9, 2022

(51) Int. Cl. G05D 1/02; B60L 7/10

(52) U.S. Cl. CPC G05D 1/0214; B60L 7/10; G05D 2201/0216

(57) ABSTRACT

Methods and systems are described herein for a navigation system that may be coupled with an object transport vehicle. The navigation system may obtain a list of objects that need to be collected and determine locations of these objects within the indoor environment. In addition, the navigation system may determine locations of other object transport vehicles and may then generate a path for the object transport vehicle so that the object transport vehicle is able to collect the objects in the list and also avoid congested parts of the indoor environment.

### BACKGROUND

Vehicle navigation has become a vital part of people's lives. In the past, people used paper maps to determine how to drive from one location to another. Later on, people used computer programs that enabled printing out directions from one location to another. Currently, navigation systems for navigating from one point to another have become ubiquitous in many handheld devices and are built into many vehicles. Some of these same systems have been adapted for object collection within indoor environments. However, indoor environments present a number of different challenges for adopting these systems. One challenge is related to a smaller space within the indoor environment leading to congestion when multiple transport vehicles are moving within that small space. Thus, paths within the indoor environment need to be optimized to avoid congested areas.

### SUMMARY

Therefore, methods and systems are described herein for facilitating indoor vehicle navigation for object collection via object transport vehicles. One indoor environment where this system may be helpful is in a warehouse that stores parts (e.g., for building objects). The warehouse may include a large number of rows where the parts may be stored and may utilize transport vehicles (e.g., self-driving carts) for part collection. However, the vehicles do not have to be self-driving in every instance. The transport vehicles may be carts that are able to move or be moved around the warehouse.

In some embodiments, the system for facilitating indoor vehicle navigation may be referred to as a navigation system. The navigation system may be coupled with a transport vehicle and may obtain a list of objects that need to be collected. The navigation system may then determine locations of these objects within the indoor environment and also locations of other transport vehicles. The navigation system may then generate a path for the transport vehicle so that the transport vehicle is able to collect the objects in the list and also avoid congested parts of the indoor environment.

In particular, the navigation system may obtain an object set associated with a user, the object set indicating objects to be collected via an object transport vehicle in an indoor environment. For example, a user may enter the indoor environment with a smartphone, an electronic tablet, or another suitable device. The navigation system may be hosted at the transport vehicle or at another suitable device. Thus, in some embodiments, the smartphone may transmit the object set (e.g., via a wireless connection) to the navigation system.

The navigation system may then determine object locations for the objects and vehicle locations for other object transport vehicles in the indoor environment. For example, the navigation system may access the received object set and perform a lookup for a location for each object in a table or in another suitable data structure. In addition, the navigation system may query a server or another suitable system for locations of other transport vehicles within the indoor environment. In some embodiments, the navigation system may transmit a wireless signal onto a wireless network to receive location information from each other vehicle within the indoor environment.

The navigation system may then generate, based on the object locations for the objects and the vehicle locations for the other object transport vehicles, navigation information related to a navigation path for collecting the objects while avoiding congestion in the indoor environment. For example, the navigation system may use a machine learning model or a regression algorithm to generate the navigation information. In some embodiments, the machine learning model may be a regression model, a neural network, or another suitable machine learning model.

When the navigation information is received, the navigation system may cause the object transport vehicle to be guided, based on the navigation information, to collect the objects associated with the user. In some embodiments, when guiding the object transport vehicle, the navigation system may automatically control braking of the object transport vehicle based on the object locations in the navigation path. For example, as the transport vehicle gets close to the location of an object in the object set, the navigation system may trigger the braking system of the transport vehicle so that the transport vehicle can be stopped at the location of the object.

In some embodiments, the transport vehicle may be a self-driving vehicle. For example, a cart may have a self-driving system on board with the navigation system being part of the self-driving system. Accordingly, the transport vehicle may have electric batteries to power itself and thus, the braking system may be a regenerative braking system that adds power to the batteries when braking is initiated.

In some embodiments, the navigation system may recalculate the navigation information at each object location. For example, when the transport vehicle is reaching a location associated with the first object, the navigation system may recalculate the navigation path based on new locations of the other vehicles and locations of other objects within the object set.

Various other aspects, features and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for facilitating indoor vehicle navigation for object collection via object transport vehicles, in accordance with one or more embodiments of this disclosure.

FIG. 2 illustrates a data structure for storing object identifiers and object metadata for the objects in the object set, in accordance with one or more embodiments of this disclosure.

FIG. 3 illustrates a data structure that stores vehicle identifiers and vehicle locations for the other vehicles in the indoor environment, in accordance with one or more embodiments of this disclosure.

FIG. 4 illustrates an exemplary machine learning model, in accordance with one or more embodiments of this disclosure.

FIG. 5 illustrates navigation information indicating a navigation path, in accordance with one or more embodiments of this disclosure.

FIG. 6 illustrates a computing device, in accordance with one or more embodiments of this disclosure.

FIG. 7 is a flowchart of operations for facilitating indoor vehicle navigation for object collection via object transport vehicles, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

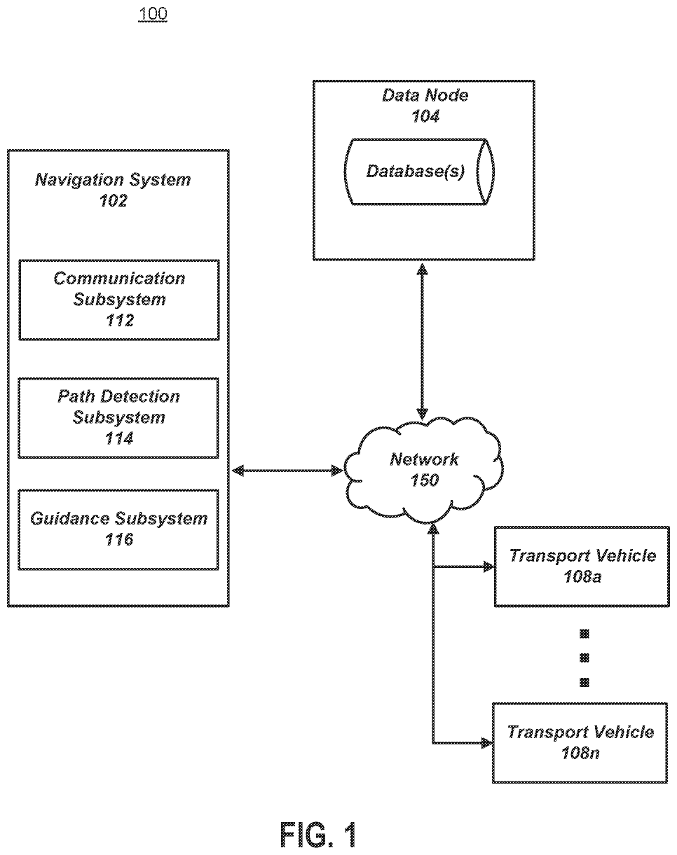

FIG. 1 is an example for facilitating indoor vehicle navigation for object collection via object transport vehicles. Environment 100 includes navigation system 102, data node 104, and transport vehicles 108a-108n (also referred to as object transport vehicles). In some embodiments, each of transport vehicles 108a-108n may include an onboard computing device that may interface with a smartphone or another smart device to receive instructions. Navigation system 102 may execute instructions for facilitating indoor vehicle navigation for object collection via object transport vehicles. Navigation system 102 may include software, hardware, or a combination of the two. For example, navigation system 102 may reside on a physical server or a virtual server that is running on a physical computer system. In some embodiments, navigation system 102 may be configured on a user device (e.g., a laptop computer, a smartphone, a desktop computer, an electronic tablet, or another suitable user device). In some embodiments, a portion of navigation system 102 may be hosted on an object transport vehicle while another portion (e.g., an application) may be hosted on a user device (e.g., a smartphone, an electronic tablet, or another suitable user device). These two portions of navigation system 102 may interface with each other to execute operations discussed below.

Data node 104 may store various data, including one or more machine learning models, training data, object lists, and/or other suitable data. In some embodiments, data node 104 may also be used to train the machine learning model. Data node 104 may include software, hardware, or a combination of the two. For example, data node 104 may be a physical server, or a virtual server that is running on a physical computer system. In some embodiments, navigation system 102 and data node 104 may reside on the same hardware and/or the same virtual server/computing device. Network 150 may be a local area network, a wide area network (e.g., the Internet), or a combination of the two. Transport vehicles 108a-108n may be carts or other suitable vehicles that may host end-user computing hardware.

Navigation system 102 may obtain an object set associated with a user. The object set may include objects to be collected via an object transport vehicle in an indoor environment. Navigation system 102 may receive the object set using communication subsystem 112. Communication subsystem 112 may include software components, hardware components, or a combination of both. For example, communication subsystem 112 may include a network card (e.g., a wireless network card and/or a wired network card) that is associated with software to drive the card. In some embodiments, communication subsystem 112 may receive the object list from data node 104 or from another computing device (e.g., from a mobile device associated with a user). For example, navigation system 102 may be hosted on an object transport vehicle. Thus, navigation system 102 may obtain the object set from a mobile device associated with the user. In some embodiments, navigation system 102 may be hosted on a device associated with a user (e.g., a smartphone). Thus, navigation system 102 may obtain the object set from another application on the user device (e.g., from a shopping application).

In some embodiments the indoor environment may be a warehouse where the object transport vehicle may be collecting parts for a particular task. Thus, the object set may include a list of parts that are needed to be collected. The object transport vehicle may be a cart that is being pushed by a user. In some embodiments, the object transport vehicle may be a self-driving cart. The object transport vehicle may have a device interface for interfacing with a user device (e.g., a smartphone). The user device may include an application for interfacing with the object transport vehicle. The application may perform the operations described herein. In some embodiments, the application may simply transmit the object set to the object transport vehicle and the operations described herein may be performed by the hardware and software associated with the object transport vehicle.

In some embodiments, the indoor environment may be a store (e.g., a supermarket) and the object transport vehicle may be a smart shopping cart. Thus, a user may walk up to a shopping cart and connect his/her smartphone to the shopping cart (e.g., via a wired or a wireless connection). In some embodiments, the connection may be via a dock. The computing device associated with the shopping cart may detect the smartphone and may interface with an application on the smartphone. The smartphone may transmit the object list (e.g., a shopping list) to the computing hardware associated with the shopping cart. Thus, navigation system 102 may obtain an object list associated with the user, in response to detecting a user using an object transport vehicle. The object list may indicate objects to be collected via the object transport vehicle in an indoor environment.

In some embodiments, the object transport vehicle may have built-in computing equipment that enables detecting mobile devices via a wireless connection (e.g., detecting smartphones via Bluetooth) and establishing connections. The built-in computing equipment may be a Bluetooth transceiver that is broadcasting a signal for establishing a connection. A smartphone in the vicinity may establish a connection with the built-in equipment. Thus, navigation system 102 may detect a connection between a mobile device of the user and the object transport vehicle. Based on the connection, navigation system 102 may detect that the user is using the object transport vehicle and may receive the object set from the mobile device of the user. For example, when the connection is established, navigation system 102 may transmit a request to the mobile device for the object set. The mobile device may include an application that is able to interface with the object transport vehicle. The application may receive the request and transmit a response to the object transport vehicle.

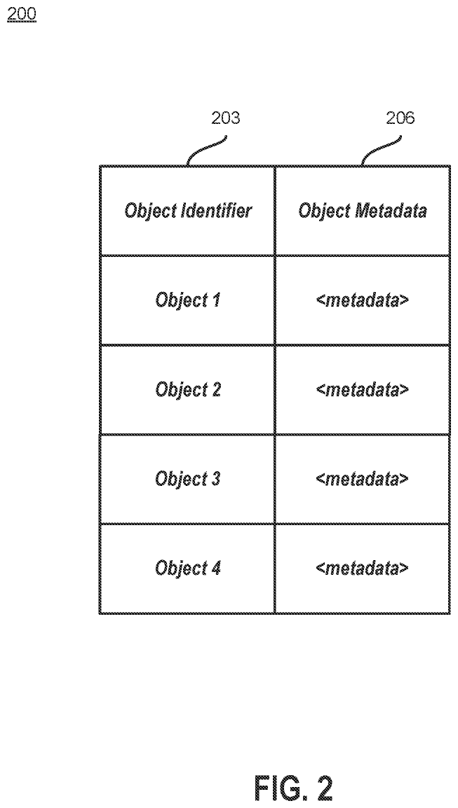

FIG. 2 illustrates a data structure 200 for storing object identifiers and object metadata for the objects in the object set. Field 203 includes object identifiers while field 206 includes object metadata for a corresponding object. For example, the object identifier may be a name of the object or another suitable identifier (e.g., a string, a number, or another suitable identifier). The object metadata may include information about the object. For example, the object metadata may include object description, part number, and/or other suitable object metadata. In some embodiments, the object metadata may include a location of the object. The location may be a row/rack number or another suitable location. In some embodiments, data structure 200 may be generated based on the object set received by navigation system 102. For example, a user may search in a mobile application for one or more parts or items to be purchased and select the objects from the list. The object set (e.g., object identifiers) may then be sent to navigation system 102, and navigation system 102 may generate data structure 200 and add suitable object metadata to the data structure.

Communication subsystem 112 may pass the object set or a pointer to the object set to path detection subsystem 114. Path detection subsystem 114 may include software components, hardware components, or a combination of both. For example, path detection subsystem 114 may include software components for accessing one or more machine learning models. Path detection subsystem 114 may access the object set, for example, in memory. Path detection subsystem 114 may determine object locations for the objects and vehicle locations for other object transport vehicles in the indoor environment.

In some embodiments, path detection subsystem 114 may perform the following operations to determine object locations. Path detection subsystem 114 may transmit one or more requests to an object repository for the object locations. The one or more requests may include object identifiers for the objects to be collected. For example, an object repository may store a plurality of object identifiers with corresponding object locations. Object locations may be in any suitable format. For example, object locations may be row/rack numbers for the objects. Path detection subsystem 114 may receive, in response to the one or more requests, one or more location identifiers for the objects to be collected. For example, the response may include a data structure that includes a plurality of object identifiers and corresponding location identifiers (e.g., row/rack numbers for the objects). Path detection subsystem 114 may then generate the object locations based on the one or more location identifiers. For example, path detection subsystem 114 may store a map that maps location identifiers to physical locations (e.g., Global Positioning System coordinates) for the rows/racks.

In some embodiments, path detection subsystem 114 may perform the following operations for determining vehicle locations for other object vehicles within the indoor environment. For example, path detection subsystem 114 may transmit a network request (e.g., a wireless network request) for locations. In some embodiments, the network request may be encrypted. Path detection subsystem 114 may receive one or more responses for the request. Each response may include an identifier of an object transport vehicle and a corresponding location. In some embodiments, path detection subsystem 114 may receive path information for each other object transport vehicle. In some embodiments path information may be referred to as navigation information.

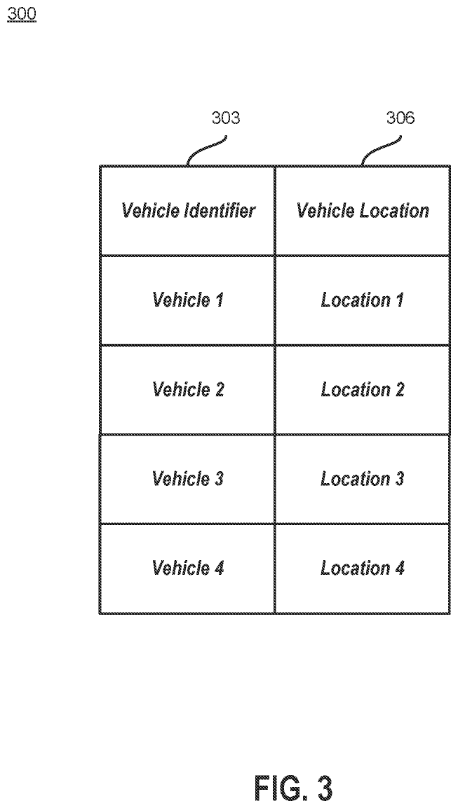

FIG. 3 illustrates a data structure storing vehicle identifiers and vehicle locations for the other vehicles in the indoor environment. Field 303 may store vehicle identifiers for a plurality of vehicles. Field 306 may store corresponding vehicle locations for the plurality of vehicles. Thus, path detection subsystem 114 may receive the vehicle identifiers and vehicle locations and generate data structure 300. In some embodiments, data structure 300 may store pathing information (not shown) for a path for each vehicle.

Path detection subsystem 114 may then generate, based on the object locations for the objects and the vehicle locations for the other object transport vehicles, navigation information related to a navigation path for collecting the objects while avoiding congestion in the indoor environment. Path detection subsystem 114 may use machine learning for generating the navigation information. For example, path detection subsystem 114 may input, into a machine learning model the object locations for the objects associated with the user and the vehicle locations for the other object transport vehicles to generate the navigation path indicating an objection collection order for collecting the objects. The machine learning model may be configured with parameters related to overall congestion in the indoor environment. Path detection subsystem 114 may receive, from the machine learning model, a plurality of locations comprising the navigation path.

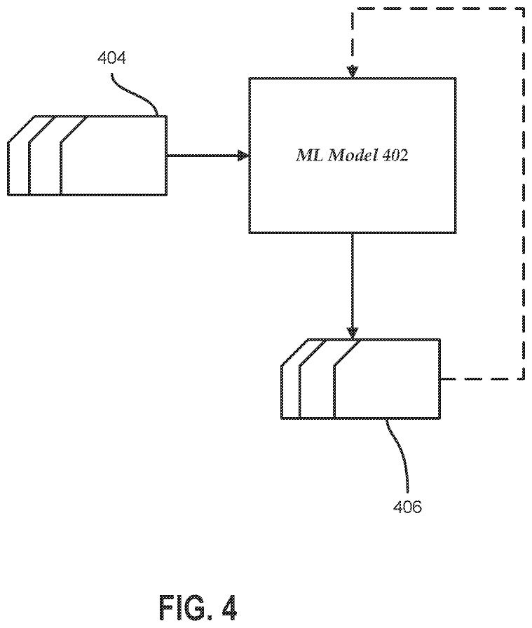

FIG. 4 illustrates an exemplary machine learning model. The machine learning model may have been trained using a training set that includes a plurality of entries with object locations and other vehicle locations. The training set may be labeled with the path information for training purposes. Machine learning model 402 may take input 404 (e.g., object locations and other vehicle locations) and may output 406 navigation information (e.g., in a form of a navigation path). The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

In some embodiments, path detection subsystem 114 or another suitable subsystem (e.g., a training subsystem) may train the machine learning model. Path detection subsystem 114 may receive a training dataset that includes a plurality of entries. Each entry may include a plurality of training object locations of a training plurality of objects. For example, the object locations may be received as row/stack numbers or in another suitable format. Each entry may also include a plurality of training vehicle locations for a training plurality of transport vehicles. For example, the vehicle locations may also be row/stack numbers to signify which vehicles are close or in the vicinity of each other. In addition, each entry may include a training navigation path indicating a corresponding objection collection order for collecting the objects associated with the user. For example, the navigation path may indicate the optimal navigation path given the object locations and the vehicle location. The optimal navigation path may be designed to avoid congestion.

Path detection subsystem 114 or another suitable subsystem may input the training dataset into a training routine of the machine learning model to train the machine learning model to output navigation paths to avoid congestion within the indoor environment. For example, the training routine may update the weights of the machine learning model for outputting navigation paths.

In some embodiments, path detection subsystem 114 may use future object transport vehicle locations to generate path information. For example, each object transport vehicle may transmit its location and its path information (e.g., identifying the path that the object transport vehicle will follow) to path detection subsystem 114. Thus, path detection subsystem 114 may determine object locations in the indoor environment for the objects associated with the user and predicted future vehicle locations for other object transport vehicles collecting other objects in the indoor environment.

Accordingly, in some embodiments, path detection subsystem 114 may input, into a machine learning model, the object locations for the objects associated with the user and the predicted future vehicle locations for the other object transport vehicles. The machine learning model may be configured with parameters related to overall congestion in the indoor environment and may generate a navigation path indicating an objection collection order for collecting the objects associated with the user. Thus, the machine learning model may take as input not only current locations of the other object transport vehicles, but also future locations of the other object transport vehicles.

In some embodiments, path detection subsystem 114 may determine locations of object transport vehicles at different times based on the received path information. In addition, path detection subsystem 114 may determine how long it will take for the object transport vehicle that the user is using to travel between different locations associated with the object set. Thus, path detection subsystem 114 may input the locations for the objects associated with the object set and sets of locations at different times into a machine learning model to obtain path information from the machine learning model. The path information may indicate an order of objects within the object set to be collected.

In some embodiments, path detection subsystem 114 may determine congestion metrics for different times and different locations within the indoor environment. For example, if at time zero several object transport vehicles are at location one, that may be a metric for that time and that location. Furthermore, if at time one several object transport vehicles may be at location two, that may be another metric determined by path detection subsystem 114. Accordingly, path detection subsystem 114 may generate a corresponding metric for each time and then input the metrics together with the object locations into a machine learning model to obtain the path information.

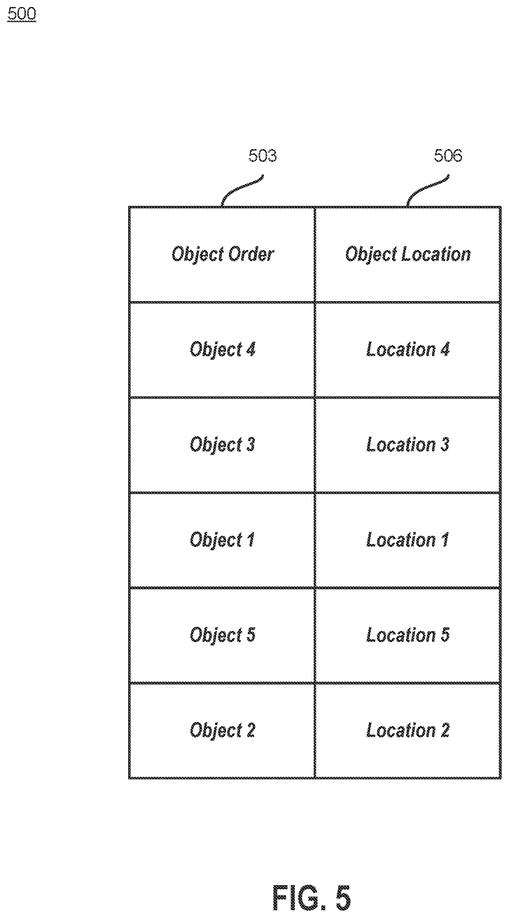

FIG. 5 illustrates navigation information indicating a navigation path. Field 503 may include object identifiers from the object set. The object identifiers may be ordered based on the navigation information. For example, the first object in the list may be navigated to first. Field 506 may store location information corresponding to each object. Location information may indicate a row/rack number or another suitable location (e.g., GPS coordinates or other suitable coordinates within the indoor environment).

Path detection subsystem 114 may then pass the navigation information to guidance subsystem 116. Guidance subsystem 116 may include software components, hardware components, or a combination of both. For example, guidance subsystem 116 may include software components that access data in memory and/or storage, and may use one or more processors to perform its operations. Guidance subsystem 116 may cause the object transport vehicle to be guided based on the navigation information to collect the objects associated with the user.

In some embodiments, in response to detecting the object transport vehicle being within an arrival threshold of an object location in the navigation path, guidance subsystem 116 may generate an arrival indication. For example, guidance subsystem 116 may generate for display (e.g., on a mobile device or on a display screen associated with the object transport vehicle) an indicator of a distance (e.g., a number of feet) until arrival. In some embodiments, guidance subsystem 116 may control regenerative braking of the object transport vehicle to guide collection of the objects associated with the user. For example, the object transport vehicle may include a power source (e.g., a battery) that can be recharged (e.g., via a power outlet or another mechanism). In addition, guidance subsystem 116 may initiate regenerative braking when within a specific distance of an object (e.g., within a particular distance of a row/rack where the object is located). In some embodiments, the braking may not be regenerative, but may be automatic. Thus, guidance subsystem 116 may automatically control braking of the object transport vehicle based on the object locations in the navigation path.

In some embodiments, as navigation system 102 navigates the object transport vehicle on the calculated path, path detection subsystem 114 may recalculate the navigation path from time to time. For example, detection subsystem 114 may recalculate the path at each or some collection points (e.g., each or at some object locations). Thus, path detection subsystem 114 may determine that the object transport vehicle reached a first location of the object locations. For example, the first location may be the first location within the path of the object transport vehicle (e.g., a first collection location). Path detection subsystem 114 may, for example, upon reaching the first object location, update both the object set and the other vehicle location information. Thus, path detection subsystem 114 may generate updated object locations by removing the first location from the object locations and/or the first object identifier from the object set.

Path detection subsystem 114 may then determine, within the indoor environment, updated vehicle locations associated with the other object transport vehicles. That is, each object transport vehicle may have moved within the indoor environment to collect the other objects. Accordingly, path detection subsystem 114 may transmit (e.g., via communication subsystem 112) a request (e.g., a wireless message) to each other object transport vehicle for a location of the object transport vehicle. Each or some of the object transport vehicles may respond with a corresponding location. Path detection subsystem 114 may then determine, using the machine learning model, an updated navigation path. Path detection subsystem 114 may perform this operation using any of the mechanisms described above.

In some embodiments, navigation system 102 may use future location information to update the navigation path. Thus, each object transport vehicle may respond with path information (e.g., a navigation path for a corresponding object transport vehicle). The path information may then be used in the machine learning model to update the navigation path.

### Computing Environment

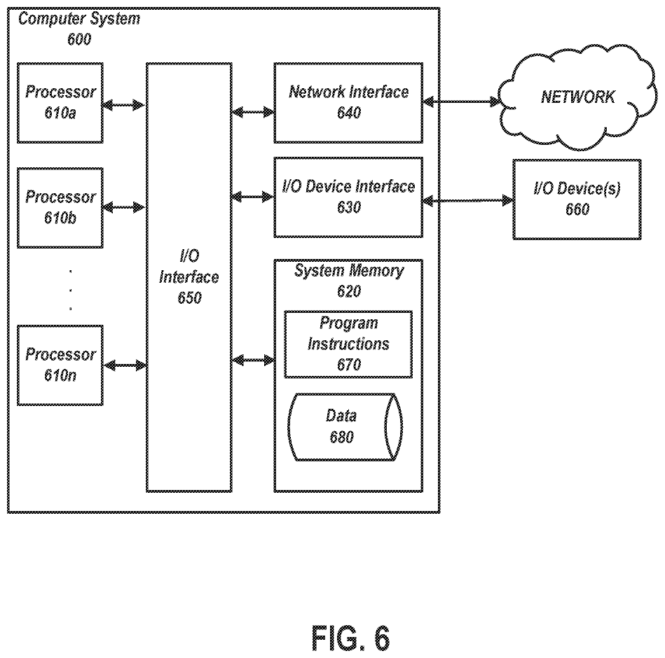

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uniprocessor system including one processor (e.g., processor 610a), or a multiprocessor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine readable storage device, a machine-readable storage substrate, a memory device, or any combination thereof. Non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative, and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

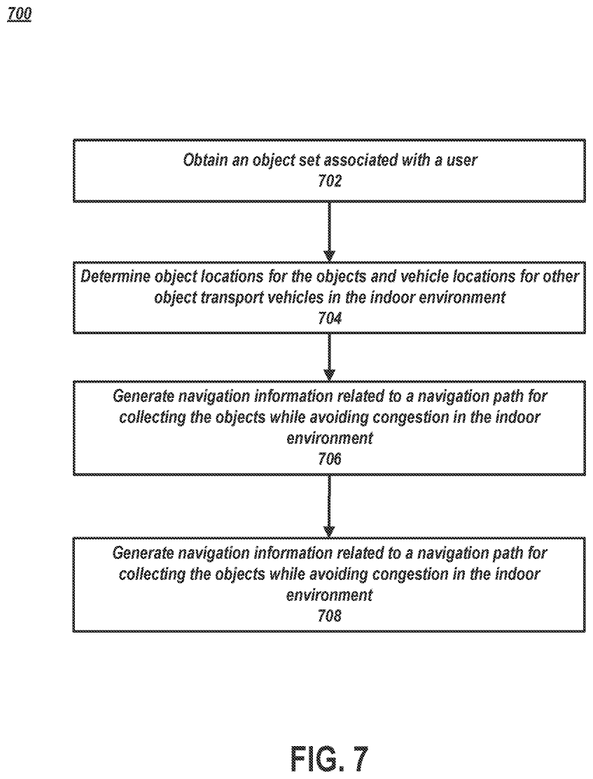

FIG. 7 is a flowchart 700 of operations for facilitating indoor vehicle navigation for object collection via object transport vehicles. The operations of FIG. 7 may use components described in relation to FIG. 6. In some embodiments, navigation system 102 may include one or more components of computer system 600. At 702, navigation system 102 obtains an object set associated with a user. For example, the navigation system 102 may receive the object set from data node 104 or from a mobile device of the user. Navigation system 102 may receive the object set over network 150 using network interface 640.

At 704, navigation system 102 determines object locations for the objects and vehicle locations for other object transport vehicles in the indoor environment. Navigation system 102 may use one or more processors 610a, 610b, and/or 610n to perform the determination. At 706, navigation system 102 generates navigation information related to a navigation path for collecting the objects while avoiding congestion in the indoor environment. For example, navigation system 102 may use one or more processors 610a-610n to perform the operation and store the results in system memory 620. At 708, navigation system 102 generates navigation information related to a navigation path for collecting the objects while avoiding congestion in the indoor environment. For example, navigation system 102 may use one or more processors 610a-610n to perform the operation and store the results in system memory 620.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for facilitating indoor vehicle navigation for object collection via object transport vehicles, the method comprising: obtaining an object set associated with a user, the object set indicating objects to be collected via an object transport vehicle in an indoor environment; determining object locations for the objects and vehicle locations for other object transport vehicles in the indoor environment; generating, based on the object locations for the objects and the vehicle locations for the other object transport vehicles, navigation information related to a navigation path for collecting the objects while avoiding congestion in the indoor environment; and causing the object transport vehicle to be guided based on the navigation information to collect the objects associated with the user.

2. Any of the preceding embodiments, wherein generating the navigation information related to the navigation path for collecting the objects comprises: inputting, into a machine learning model configured with parameters related to overall congestion in the indoor environment, the object locations for the objects associated with the user and the vehicle locations for the other object transport vehicles to generate the navigation path indicating an objection collection order for collecting the objects; and receiving, from the machine learning model, a plurality of locations comprising the navigation path.

3. Any of the preceding embodiments, further comprising: receiving a training dataset comprising a plurality of entries, wherein each entry comprises (1) a plurality of training object locations of a training plurality of objects, (2) a plurality of training vehicle locations for a training plurality of transport vehicles, and (3) a training navigation path indicating a corresponding objection collection order for collecting the objects associated with the user; and inputting the training dataset into a training routine of the machine learning model to train the machine learning model to output navigation paths to avoid congestion within the indoor environment.

4. Any of the preceding embodiments further comprising: determining that the object transport vehicle reached a first location of the object locations; generating updated object locations by removing the first location from the object locations; determining, within the indoor environment, updated vehicle locations associated with the other object transport vehicles, wherein each other object transport vehicle moves within the indoor environment to collect other objects; and determining, using the machine learning model, an updated navigation path.

5. Any of the preceding embodiments, further comprising causing the object transport vehicle to be guided along the navigation path, wherein causing the object transport vehicle to be guided along the navigation path comprises automatically controlling braking of the object transport vehicle based on the object locations in the navigation path.

6. Any of the proceeding embodiments, further comprising: detecting a connection between a mobile device of the user and the object transport vehicle; based on the connection, detecting that the user is using the object transport vehicle; and receiving the object set from the mobile device of the user.

7. Any of the preceding embodiments, wherein determining the object locations for the objects in the indoor environment comprises: transmitting one or more requests to an object repository for the object locations, wherein the one or more requests comprise object identifiers for the objects to be collected; receiving, in response to the one or more requests, one or more location identifiers for the objects to be collected; and generating the object locations based on the one or more location identifiers.

8. Any of the preceding embodiments, further comprising causing regenerative braking to be engaged within a predetermined distance of each object location.

9. A tangible, non-transitory, machine-readable medium storing instructions that, when executed by a data processing apparatus, cause the data processing apparatus to perform operations comprising those of any of embodiments 1-8.

10. A system comprising: one or more processors; and memory storing instructions that, when executed by the processors, cause the processors to effectuate operations comprising those of any of embodiments 1-8.

11. A system comprising means for performing any of embodiments 1-8.

12. A system comprising cloud-based circuitry for performing any of embodiments 1-8.

What is claimed is:

1. A system for facilitating indoor vehicle navigation for object collection via object transport vehicles, the system comprising:
one or more processors; and
a non-transitory computer-readable storage medium storing instructions that, when executed by the one or more processors, cause the one or more processors to perform operations comprising:
in response to detecting a user using an object transport vehicle, obtaining an object list associated with the user, the object list indicating objects to be collected via the object transport vehicle in an indoor environment;
determining (i) object locations in the indoor environment for the objects associated with the user and (ii) predicted future vehicle locations for other object transport vehicles collecting other objects in the indoor environment;
inputting, into a machine learning model configured with parameters related to overall congestion in the indoor environment, the object locations for the objects associated with the user and the predicted future vehicle locations for the other object transport vehicles to generate a navigation path indicating an objection collection order for collecting the objects associated with the user; and
in response to detecting the object transport vehicle being within an arrival threshold of an object location in the navigation path, generating an arrival indication and controlling regenerative braking of the object transport vehicle to guide collection of the objects associated with the user.

2. The system of claim 1, wherein the instructions further cause the one or more processors to perform operations comprising:
determining that the object transport vehicle reached a first location of the object locations;
generating updated object locations by removing the first location from the object locations;
determining, within the indoor environment, updated predicted future vehicle locations associated with the other object transport vehicles, wherein each other object transport vehicle moves within the indoor environment to collect the other objects; and
determining, using the machine learning model, an updated navigation path.

3. The system of claim 1, wherein the instructions further cause the one or more processors to perform operations comprising:
receiving a training dataset comprising a plurality of entries, wherein each entry comprises (1) a plurality of training object locations of a training plurality of objects, (2) a plurality of training predicted future vehicle locations for a training plurality of transport vehicles, and (3) a training navigation path indicating a corresponding objection collection order for collecting the objects associated with the user; and
inputting the training dataset into a training routine of the machine learning model to train the machine learning model to output navigation paths to avoid congestion within the indoor environment.

4. The system of claim 1, wherein the instructions further cause the object transport vehicle to be guided along the navigation path.

5. A method for facilitating indoor vehicle navigation for object collection via object transport vehicles, the method comprising:
obtaining an object set associated with a user, the object set indicating objects to be collected via an object transport vehicle in an indoor environment;
determining object locations for the objects and vehicle locations for other object transport vehicles in the indoor environment;
generating, based on the object locations for the objects and the vehicle locations for the other object transport vehicles, navigation information related to a navigation path for collecting the objects while avoiding congestion in the indoor environment; and
causing the object transport vehicle to be guided based on the navigation information to collect the objects associated with the user.

6. The method of claim 5, wherein generating the navigation information related to the navigation path for collecting the objects comprises:
inputting, into a machine learning model configured with parameters related to overall congestion in the indoor environment, the object locations for the objects associated with the user and the vehicle locations for the other object transport vehicles to generate the navigation path indicating an objection collection order for collecting the objects; and
receiving, from the machine learning model, a plurality of locations comprising the navigation path.

7. The method of claim 6, further comprising:
receiving a training dataset comprising a plurality of entries, wherein each entry comprises (1) a plurality of training object locations of a training plurality of objects, (2) a plurality of training vehicle locations for a training plurality of transport vehicles, and (3) a training navigation path indicating a corresponding objection collection order for collecting the objects associated with the user; and
inputting the training dataset into a training routine of the machine learning model to train the machine learning model to output navigation paths to avoid congestion within the indoor environment.

8. The method of claim 6, further comprising:
determining that the object transport vehicle reached a first location of the object locations;
generating updated object locations by removing the first location from the object locations;
determining, within the indoor environment, updated vehicle locations associated with the other object transport vehicles, wherein each other object transport vehicle moves within the indoor environment to collect other objects; and
determining, using the machine learning model, an updated navigation path.

9. The method of claim 5, further comprising causing the object transport vehicle to be guided along the navigation path, wherein causing the object transport vehicle to be guided along the navigation path comprises automatically controlling braking of the object transport vehicle based on the object locations in the navigation path.

10. The method of claim 5, further comprising:
detecting a connection between a mobile device of the user and the object transport vehicle;
based on the connection, detecting that the user is using the object transport vehicle; and
receiving the object set from the mobile device of the user.

11. The method of claim 5, wherein determining the object locations for the objects in the indoor environment comprises:
transmitting one or more requests to an object repository for the object locations, wherein the one or more requests comprise object identifiers for the objects to be collected;
receiving, in response to the one or more requests, one or more location identifiers for the objects to be collected; and
generating the object locations based on the one or more location identifiers.

12. The method of claim 5, further comprising causing regenerative braking to be engaged within a predetermined distance of each object location.

13. A non-transitory computer-readable medium for facilitating indoor vehicle navigation for object collection via object transport vehicles, storing instructions that, when executed by one or more processors, cause the one or more processors to perform operations comprising:
obtaining an object set associated with a user, the object set indicating objects to be collected via an object transport vehicle in an indoor environment;
determining object locations for the objects and vehicle locations for other object transport vehicles in the indoor environment;
generating, based on the object locations for the objects and the vehicle locations for the other object transport vehicles, navigation information related to a navigation path for collecting the objects while avoiding congestion in the indoor environment; and
causing the object transport vehicle to be guided based on the navigation information to collect the objects associated with the user, wherein guiding the object transport vehicle comprises automatically controlling braking of the object transport vehicle based on the object locations in the navigation path.

14. The non-transitory computer-readable medium of claim 13, wherein the instructions for generating the navigation information related to the navigation path for collecting the objects cause the one or more processors to perform operations comprising:
inputting, into a machine learning model configured with parameters related to overall congestion in the indoor environment, the object locations for the objects associated with the user and the vehicle locations for the other object transport vehicles to generate the navigation path indicating an objection collection order for collecting the objects; and
receiving, from the machine learning model, a plurality of locations comprising the navigation path.

15. The non-transitory computer-readable medium of claim 14, wherein the instructions further cause the one or more processors to perform operations comprising:
receiving a training dataset comprising a plurality of entries, wherein each entry comprises (1) a plurality of training object locations of a training plurality of objects, (2) a plurality of training vehicle locations for a training plurality of transport vehicles, and (3) a training navigation path indicating a corresponding objection collection order for collecting the objects associated with the user; and
inputting the training dataset into a training routine of the machine learning model to train the machine learning model to output navigation paths to avoid congestion within the indoor environment.

16. The non-transitory computer-readable medium of claim 14, wherein the instructions further cause the one or more processors to perform operations comprising:
determining that the object transport vehicle reached a first location of the object locations;
generating updated object locations by removing the first location from the object locations;
determining, within the indoor environment, updated vehicle locations associated with the other object transport vehicles, wherein each other object transport vehicle moves within the indoor environment to collect other objects; and
determining, using the machine learning model, an updated navigation path.

17. The non-transitory computer-readable medium of claim 13, wherein the instructions further cause the one or more processors to cause the object transport vehicle to be guided along the navigation path.

18. The non-transitory computer-readable medium of claim 13, wherein the instructions further cause the one or more processors to perform operations comprising:
detecting a connection between a mobile device of the user and the object transport vehicle;
based on the connection, detecting that the user is using the object transport vehicle; and
receiving the object set from the mobile device of the user.

19. The non-transitory computer-readable medium of claim 13, wherein the instructions for determining the object locations for the objects in the indoor environment cause the one or more processors to perform operations comprising:
transmitting one or more requests to an object repository for the object locations, wherein the one or more requests comprise object identifiers for the objects to be collected;
receiving, in response to the one or more requests, one or more location identifiers for the objects to be collected; and
generating the object locations based on the one or more location identifiers.

20. The non-transitory computer-readable medium of claim 13, wherein the instructions for automatically controlling the braking of the object transport vehicle based on the object locations in the navigation path further cause the one or more processors to cause regenerative braking to be engaged within a predetermined distance of each object location.
